(19) United States
(12) Patent Application Publication
(10) Pub. No.: US 2007/0057784 A1
(43) Pub. Date: Mar. 15, 2007

(54) Displaying advertisements by security pannels of a central station security system

(75) Inventor: Nithyanandhan Govindaraj, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/227,397

(22) Filed: Sep. 15, 2005

(51) Int. Cl. G08B 13/00

(52) U.S. Cl. 340/541

(57) ABSTRACT

A security panel of a central station security system has one or more sensors that sense alarm conditions with respect to a facility of a user, a transceiver that transmits an alarm condition to a central station of the central station security system, a display, and a processor. The processor is coupled to the sensors, to the transceiver, and to the display, and the processor causes advertisements to be presented to the user on the display.

### TECHNICAL FIELD OF THE INVENTION

The present invention relates to a security panel that receives and displays advertisements such as those broadcast by, for example, a central station providing a security service to a user of the security panel.

### BACKGROUND OF THE INVENTION

Advertisers use various media in order to advertise their goods and services. For example, newspapers, magazines, and other printed material contain advertisements that are viewed by the readers of such printed material.

Also, advertisements are transmitted in television and radio signals that are broadcast by such sources as over-the-air networks, satellite providers, and cable head ends. Receivers having antennae, satellite dishes, and/or cable modems receive the television and radio signals and display the advertisements to viewers and listeners during commercial breaks in the programming also contained in the television and radio signals.

Television and radio signals have also been supplied over the Internet. Accordingly, a tuning card in a computer provides the computer with a tuning capability so that the television and/or radio signals can be received by the computer that then plays the programming contained in the television and radio signals to the computer user. Advertisements that are embedded in the television and radio signals to which the computer is tuned are also played to the computer user.

Advertising banners have also been provided as part of web pages that are downloaded to a user's computer whenever the user accesses these web pages. Moreover, pop overs and pop unders containing advertisements are frequently downloaded to the user's computer as the user navigates through the Internet.

The present invention offers an additional vehicle by which advertisers can advertise their products and services to users, a vehicle that no one until the present invention has thought to use for the distribution of advertisements.

### SUMMARY OF THE INVENTION

In accordance with one aspect of the present invention, a security panel of a central station security system comprises a sensor, a transmitter, a display, and a processor. The sensor senses an alarm condition with respect to a facility of a user. The transmitter transmits the alarm condition to a central station of the central station security system. The processor is coupled to the sensor, to the transmitter, and to the display, and the processor causes an advertisement to be presented to the user on the display.

In accordance with another aspect of the present invention, a security system comprises a plurality of sensors, a processor, a memory, and a display. The sensors monitor security of an area protected by the security system. The processor receives a message from a source, the message contains an address, and the processor uses the address to request download of information. The memory stores the received message. The display displays the received message.

In accordance with still another aspect of the present invention, a method implemented by geographically dispersed security panels of a central station security service comprises the following: sensing an alarm condition indicating a breach of security; transmitting the sensed alarm condition to a central station of the central station security system; receiving an advertisement; and, displaying the advertisement.

### BRIEF DESCRIPTION OF THE DRAWINGS

These and other features and advantages will become more apparent from a detailed consideration of the invention when taken in conjunction with the drawings in which:

FIG. 1 illustrates a typical central station security system that is configured according to one embodiment of the present invention to distribute advertisements to the users of the security service provided by central station security system;

FIG. 2 illustrates an example of a central station that can be part of the central station security system shown in FIG. 1;

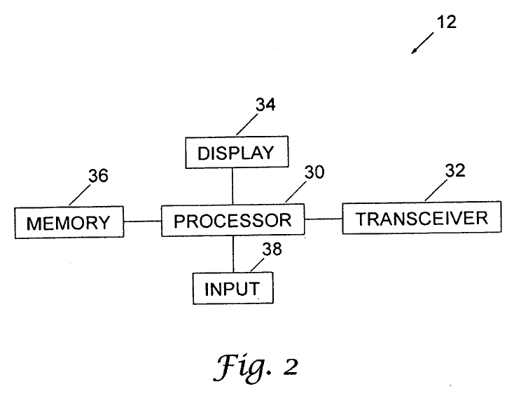

FIG. 3 illustrates an example of a security panel that can be located at a facility of a user of the security service provided by the central station security system shown in FIG. 1; and,

FIG. 4 illustrates an example of a program that can be executed by the panels of the central station security system of FIG. 1 in order to display advertisements provided to the users of the secure service offered by the central station security system of FIG. 1.

### DETAILED DESCRIPTION

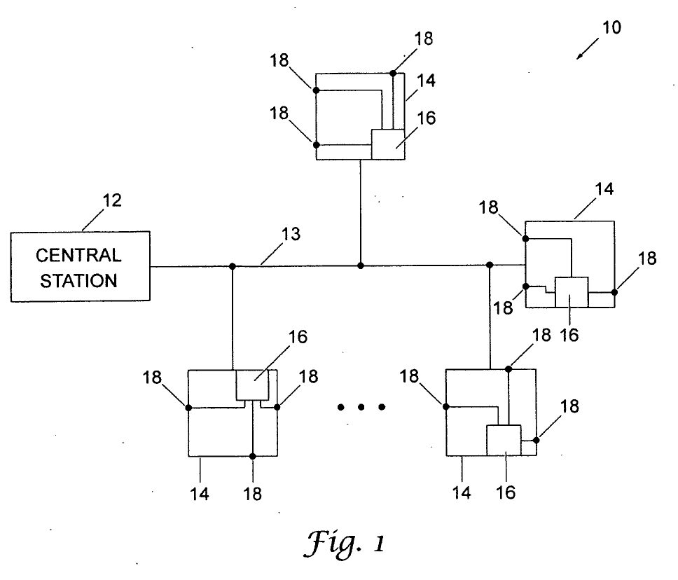

As shown in FIG. 1, a central station security system 10 includes a central station 12 that is coupled by a communication medium 13 to remotely distributed facilities 14 of the users of the security service provided by the central station security system 10. Each of the facilities 14 has at least one security panel 16 that is coupled to one or more sensors 18 that sense various conditions.

The communication medium 13, for example, may be a telephone system such as POTS (plain old telephone system), a cellular system, a satellite system, etc. Alternatively, cable systems, the Internet, or other communication media can be used to interconnect the security panels 16 to the central station 12 of the central station security system 10.

The sensors 18 sense various conditions such as alarm conditions relative to the facilities 14. For example, the sensors 18 can be intrusion detectors such as door sensors, window sensors, glass breakage sensors, motion sensors, and/or pressure sensors under mats or rugs. The sensors 18 can also include smoke and/or fire detectors, carbon monoxide sensors, and/or other sensors that sense potentially injurious conditions within the facilities of the users 14.

As is typical with central station security systems, the security panel 16 within a corresponding one of the facilities 14 transmits an alarm signal to the central station 12 over the communication medium 13 whenever one of the sensors 18 detects an alarm condition such as an intrusion. For example, the security panel 16 may initiate a telephone call to the central station 12, and uses the call to transmit the identity of the corresponding facility 14 whose security panel 16 initiated the call. Also, the call may identify the particular sensor 18 that detected the alarm condition. The central station 12 then contacts security personnel who are discharged to the appropriate facility 14 to investigate the condition that gave rise to the alarm. The security personnel may be private security guards and/or police.

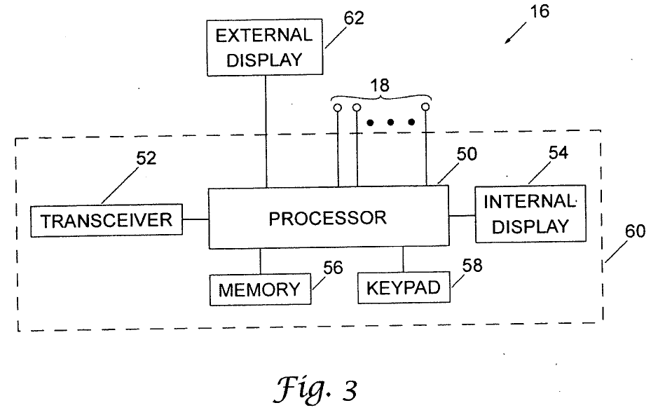

An example of a central station that can be used for the central station 12 is shown in FIG. 3. According to this example, the central station 12 has a processor 30, a transceiver 32, a display 34, a memory 36, and an input 38. The processor 30 may be one or more computers having a size dependent upon the number of facilities 14 whose users avail themselves of the central station security protection offered by the central station 12.

The transceiver 32, for example, can be any device appropriate to the particular type of communication medium that is used for the communication medium 13 and that is used to convey alarms and information between the central station 12 and the panels 16.

The display 34 may be a screen, a printer, one or more speakers, and/or any other device capable of displaying or providing information to an attendant. In the case of alarms, the display 34 provides the attendant with sufficient information that the attendant can evaluate the alarm conditions and can direct the appropriate personnel to respond to the alarm condition at the appropriate one of the facilities 14. Alternatively, the processor 30 can be arranged to automatically notify the appropriate personnel by way of the transceiver 32.

The memory 36 stores appropriate programs that are executed by the processor 30 to conduct the business of the central station 12. Additionally, the memory 36 stores information appropriate to a central station business. For example, the memory 36 may store telephone numbers, addresses, and identity codes associated with each of the facilities 14 as well as contact information for the personnel who are appropriate to each of the facilities 14 and who will be contacted by the central station 12 in the event of a condition, such as an alarm condition, warranting such a contact.

The input 38, for example, may be a keyboard, mouse, and/or any other device suitable for programming, inputting information into, and/or controlling the central station 12.

A representative one of the panels 16 may be constructed by way of example in the manner suggested by FIG. 3. As shown in FIG. 3, the security panel 16 has a processor 50, a transceiver 52, an internal display 54, a memory 56, and an input 58. The processor 50 may be a microprocessor, an ASIC, a programmable logic array, or any other device suitable for carrying out the functions of the security panel 16. Accordingly, the processor 50, which is coupled to its corresponding sensors 18, uses the transceiver 52 to contact the central station 12 in the event of an alarm condition at the facility 14.

The transceiver 52, for example, can be any device appropriate to the particular type of the communication medium 13 that is used to convey alarms and information between the central station 12 and the panels 16.

The internal display 54 may be a screen, a flat panel, and/or any other device that is supported by a housing 60 of the security panel 16 and that is capable of providing information to the corresponding user 14. For example, the internal display 54 may be used by the central station 12 or other source to display information such as advertisements to the user of the facility 14. Also, the user of the facility 14 can use the internal display 54 to appropriately arm all of the area of the facility 14 or to arm only one or more selected areas or zones of the facility 14. The internal display 54 may also includes lights or other devices to assist the user in the use of the security panel 16.

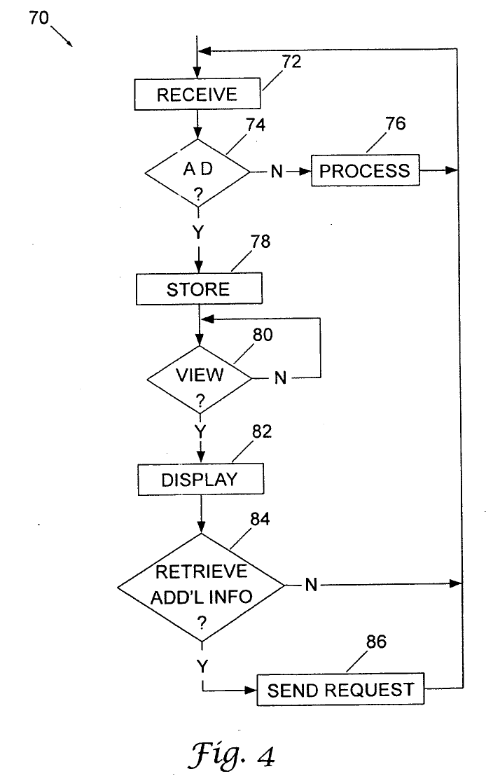

The memory 56 may or may not be required depending upon the particular type of device that is used for the processor 50. Assuming that the processor is some form of computer that executes software, the memory 56 stores, for example, appropriate programs that are executed by the processor 50 to carry out the functions of the security panel 16. Additionally, the memory 36 can store data such as the appropriate contact information of the central station 12. For example, the memory 56 can store the telephone number or other address of the central station 12 so that the security panel 16 can contact the central station 12 in the event of an alarm condition. However, other devices may not require the memory 56, in which case the functionality of the program illustrated in FIG. 4 as well as the other functionality appropriate to the security panel 16 may be embedded in logic or other hardware of the particular device.

The input 58, for example, may be a keypad, a touchpad; switches, and/or any other device or devices suitable for programming, inputting data into, and/or controlling the security panel 16. The input 58 may also be used to arm or de-arm the security panel 16 so that the security panel 16 will initiate a call to the central station as alarm conditions are detected by appropriate ones of the sensors 18.

Additionally or alternatively, the processor 50 can download the advertisement that the security panel 16 receives from the central station 12 (or otherwise) to an external display 62. The external display 62 can be a monitor, a television, a personal computer, a cellular telephone, a PDA, or any other device capable of displaying the advertisement to the user. This feature is particularly useful in connection with those security panels not equipped with an internal display such as the internal display 54.

The processor 50 of the security panel 16 executes a program (firmware and/or software and/or the like) that, inter alia, causes advertisements received from a source such as the central station 12 to be displayed on the internal display 54 of the security panel 16. An example of this program is shown in FIG. 4 as a program 70. The program 70, for example, may be an event initiated program.

According to the example program 70, the security panel 16 receives a communication at 72 and, if this communication does not contain an advertisement as determined at 74, the communication is processed appropriately at 76. For example, the communication received by the security panel 16 may contain instructions regarding the programming or configuration of the security panel 16, and these instructions can be implemented at 76.

If the received communication contains an advertisement as determined at 74, the security panel 16 may be arranged to immediately display the advertisement on the internal display 54. Alternatively, additional flexibility can be provided to the security panel 16 by arranging the program 70 to store the received advertisement in the memory 56 as indicated at 78. Thus, when the stored advertisement is to be viewed as determined at 80, the stored advertisement is displayed at 82 for a predetermined amount of time or until the user determines to terminate the display of the advertisement and/or to delete the advertisement.

The processor 50 may be arranged at 80 to determine that it is time to view the stored advertisement based upon a manual operation of the user. For example, the program 70 may determine at 80 that the user has input a manually instruction instructing the security panel 16 to display the stored advertisement.

If desired, the program 70 can be arranged at 84 to determine whether the user desires additional information about the goods or services being offered by the advertisement. For example, the advertisement being displayed to the user or the message that is received at 72 from a source may contain an address to a source of this additional information. This source of additional information may be the same source as the source of the advertisement or message or it may be a different source. If the user desires such additional information as determined at 84, the program at 86 transmits a request to the address for the additional information. The address can be URL, and the processor 50 may be arranged to use the URL through the external device 62 or other connection in order to obtain the additional information.

Certain modifications of the present invention have been discussed above. Other modifications of the present invention will occur to those practicing in the art of the present invention. For example, as described above, the security panel 16 is configured to display advertisements received from the central station 12. Alternatively, the security panel 16 may be configured to display advertisements received from sources other than the central station 12. For example, the security panel 16 may be provided with receivers and/or modems that permit it to display advertisements received from other sources such as television stations, radio stations, cable head ends, satellite transmitters, the Internet, etc. As another example, advertisements can also be downloaded from a separate downloading station that is solely devoted to the download of advertisements or which may also be responsible both for the download of advertisements and for configuring the panel 16.

Also, the security panel 16 can receive advertisements at 72 that are automatically sent by a source. In this case, the source establishes a connection to the security panel 16. For example, if the source is the central station 12, the connection may be a telephone connection to the security panel 16. The connection is then used to transmit the advertisements to the security panel 16.

Moreover, the advertisements discussed above can be single frame advertisements, the advertisements can contain hotlinks to web sites, the advertisements can comprises video, audio, and/or multimedia streams, etc.

Furthermore, although not shown in FIG. 4, the program 70 may also include the code that causes an alarm to be transmitted from the security panel 16 to the central station 12 and that performs the other functions appropriate to the security panel 16.

Alternatively or additionally, the security panel 16 may be arranged to require a specific manual user instruction at 72 in order to retrieve advertisements from a source. In this latter case, the security panel 16 can be arranged to transmit a message to the source instructing the source to transmit any advertisements that it has to the security panel 16. If desired, this message can alternatively specify advertisements of interest by subject matter criteria or other criteria so that only selected advertisements are downloaded by the source to the security panel 16 for viewing by the user. Similarly, the security panel 16 may be arranged at 80 and 82 to apply user specified subject matter criteria or other criteria in order to select from the memory 56 only certain advertisements for viewing by the user.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A security panel of a central station security system comprising:
a sensor that senses an alarm condition with respect to a facility of a user;
a transmitter that transmits the alarm condition to a central station of the central station security system;
a display; and,
a processor coupled to the sensors, to the transmitter, and to the display, the processor causing an advertisement to be presented to the user on the display.

2. The security panel of claim 1 wherein the advertisement is received from the central station.

3. The security panel of claim 1 wherein the transmitter comprises a receiver that receives the advertisement.

4. The security panel of claim 3 wherein the advertisement is received from the central station.

5. The security panel of claim 1 wherein the display comprises an internal display.

6. The security panel of claim 1 wherein the display comprises an external display.

7. The security panel of claim 1 wherein the processor permits a user to initiate download of the advertisement from a remote source.

8. The security panel of claim 1 wherein the processor permits a user to specify selection criteria in order to select the advertisement according to the selection criteria.

9. A security system comprising:
a plurality of sensors that monitor security of an area protected by the security system;
a processor that receives a message from a source, wherein the message contains an address, and wherein the processor uses the address to request download of information;
a memory that stores the received message; and,
a display that displays the received message.

10. The security system of claim 9 wherein the received message contains an advertisement, and wherein the display displays the advertisement.

11. The security system of claim 9 wherein the display displays the information.

12. The security system of claim 9 wherein the address comprises a URL.

13. The security system of claim 9 wherein the information comprises video, audio, and/or multimedia streams.

14. The security system of claim 9 wherein the source comprises a central station to which the processor transmits alarm messages.

15. The security system of claim 9 wherein the display comprises an internal display.

16. The security system of claim 9 wherein the display comprises an external display.

17. The security system of claim 9 wherein the processor permits a user to initiate download of the information.

18. The security system of claim 9 wherein the processor permits a user to specify selection criteria in order to select the information according to the selection criteria.

19. A method implemented by geographically dispersed security panels of a central station security service comprising:
sensing an alarm condition indicating a breach of security;
transmitting the sensed alarm condition to a central station of the central station security system;
receiving an advertisement; and,
displaying the advertisement.

20. The method of claim 19 wherein the advertisement contains an address associated with additional information.

21. The method of claim 20 wherein the address comprises a URL.

22. The method of claim 19 wherein the advertisement comprises a video, audio, and/or multimedia stream.

23. The method of claim 19 wherein the receiving of an advertisement comprises receiving the advertisement from the central station.

24. The method of claim 19 wherein the receiving of an advertisement comprises receiving the advertisement from a source other than the central station.

25. The method of claim 19 wherein the receiving of an advertisement comprises initiating receipt of the advertisement from the security panel.

26. The method of claim 19 wherein the receiving of an advertisement comprises initiating receipt of the advertisement from the security panel based on selection criteria specified at the security panel.
